(19) United States
(12) Patent Application Publication
(10) Pub. No.: US 2015/0094650 A1
(43) Pub. Date: Apr. 2, 2015

(54) SELF-EVACUATING DOSE CUP FOR DISPENSING LIQUID MEDICINE

(71) Applicant: Tessy Plastics Corporation, Elbridge, NY (US)

(72) Inventor: David Young, Syracuse, NY (US)

(73) Assignee: Tessy Plastics Corporation

(21) Appl. No.: 14/500,094

(22) Filed: Sep. 29, 2014

Related U.S. Application Data
(60) Provisional application No. 61/884,505, filed on Sep. 30, 2013.

(51) Int. Cl. A61J 7/00

(52) U.S. Cl. CPC A61J 7/0046
USPC 604/78

(57) ABSTRACT

A dose cup for dispensing liquid medication is disclosed. An inner cavity of the dose cup is surface-coated with a plurality of microstructures that provides a hydrophobic surface that aids in the self-evacuation of liquid medicine. Because the dose cup is self-evacuating, the volume of liquid medicine that is dispensed can be accurately controlled.

### CROSS-REFERENCE TO RELATED APPLICATIONS

This application is a non-provisional of U.S. patent application Ser. No. 61/884,505 (filed Sep. 30, 2013) the entirety of which is incorporated herein by reference.

### BACKGROUND OF THE INVENTION

The subject matter disclosed herein relates to dose cups for dispensing a measured quantity of liquid, for example, liquid medication.

Many dose cups have gradations for measuring a dose of a liquid medication intended for a patient. The gradations are scaled to account for an average amount of liquid medication that remains in the dose cup after use. For example, a variable amount of liquid medication may adhere to an internal surface and impact the amount of liquid medication that remains in the dose cup. Unfortunately, this average amount can vary substantially from one dose to the next dose. Internal surfaces of many dose cups are also prone to accumulate contamination which can result in accidental poisoning of the patient. An improved dose cup is therefore desired that addresses at least some of these problems.

The discussion above is merely provided for general background information and is not intended to be used as an aid in determining the scope of the claimed subject matter.

### BRIEF DESCRIPTION OF THE INVENTION

A dose cup for dispensing liquid medication is disclosed. An inner cavity of the dose cup is surface-coated with a plurality of microstructures that provides a hydrophobic surface that aids in the self-evacuation of liquid medicine. Because the dose cup is self-evacuating, the volume of liquid medicine that is dispensed can be accurately controlled.

In a first embodiment, a dose cup for dispensing liquid medication is provided. The dose cup comprises a vertical sidewall and a bottom wall joined together by a curved inner surface to define an inner cavity, where the inner cavity is surface-coated with a plurality of microstructures that provides a hydrophobic surface to produce a contact angle greater than 90° when tested in accordance with ASTM D7334-08(2013). The dose cup comprises a polymeric material.

In a second embodiment, a dose cup for dispensing liquid medication is provided. The dose cup comprises a vertical sidewall and a bottom wall joined together by a curved inner surface to define an inner cavity, where the inner cavity is surface-coated with a plurality of microstructures that provides a hydrophobic surface to produce a contact angle greater than 90° when tested in accordance with ASTM D7334-08(2013). The dose cup comprises a polymeric material. The plurality of microstructures comprise columns, each with a height, a width and a top planar surface, the height being at least twice the width, the columns being spaced apart by a gap that is equal to or less than the width.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A, FIG. 1B and FIG. 1C provide a perspective view, side view and cross section view, respectively, of an exemplary dose cup;

FIG. 2A and FIG. 2B are schematic depictions of microstructures that accentuates the ability of a dose cup to dispense a controlled volume of liquid medication;

FIG. 3 depicts the microstructures in further detail;

FIG. 4A and FIG. 4B schematically depict the microstructures along a curved inner surface;

FIG. 5A, FIG. 5B and FIG. 5C provide a side view, a bottom plan view and a bottom plan view, respectively, of an exemplary dose cup;

FIG. 6A, FIG. 6B, FIG. 6C and FIG. 6D provide a plan side view, a cross section view, another plane side view in a tipped state and a top perspective view of an exemplary dose cup;

FIG. 7 is a bottom perspective view of an exemplary dose cup;

FIG. 8A, FIG. 8B, FIG. 8C and FIG. 8D provide a plan side view, a cross section view, a bottom perspective view and a bottom plan view of an exemplary dose cup; and

FIG. 9 is a top perspective view of the exemplary dose cup of FIG. 8A showing a concave cavity.

### DETAILED DESCRIPTION OF THE INVENTION

The dose cups disclosed herein are useful in dispensing liquid medications. The dose cups have a bottom wall and a sidewall which are joined to one another by a curved inner surface such that a cavity of the dose cup is smooth and lacks corners. Advantageously, because there are no corners, liquid medications do not become stuck in the corners. This permits dose cup manufacturers more accurate control over dosing—the gradations are based on actual volumes of liquid medications and are not based on a theoretical average amount of residual medication that remains in the dose cup after use. The dose cup may be formed from a polymeric material, such as polypropylene. Suitable manufacturing methods include, for example, injection molding. In one embodiment, the dose cup is surface treated after molding to increase the hydrophobicity of the inner surface. This surface treatment further accentuates the ability of the dose cup to dispense a controlled volume of liquid medication.

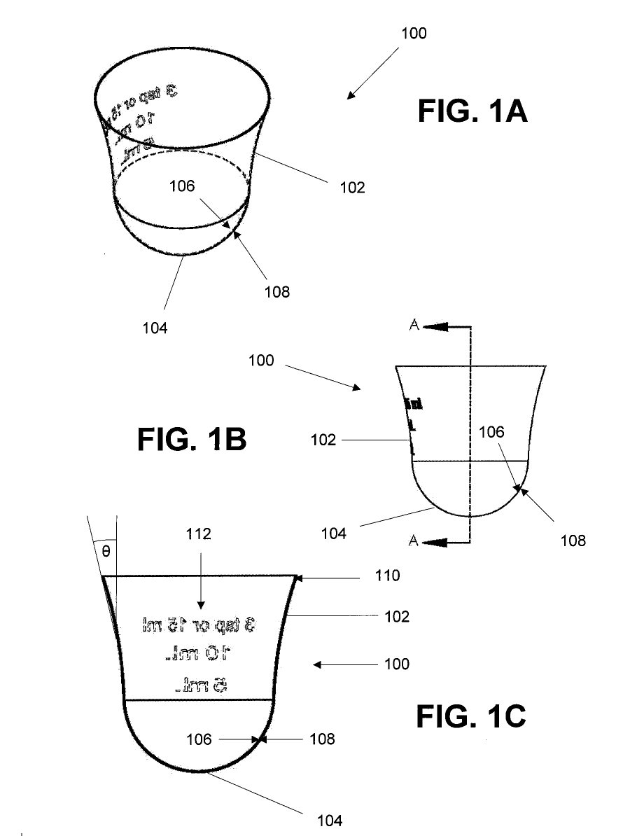

FIG. 1A, FIG. 1B and FIG. 1C are depictions of a dose cup 100. FIG. 1A is a perspective view of the dose cup 100. FIG. 1B is a side view of the dose cup 100. FIG. 1C is a cross section view along line A-A of FIG. 1B. The dose cup 100 comprises a vertical sidewall 102 and a bottom wall 104 joined by a curved inner surface 106. In the exemplary embodiment the dose cup 100 also has a curved outer surface 108 that is opposite the curved inner surface 106 and the bottom wall 104 is curved to provide a fully rounded bottom such that its curved outer surface lacks a planar surface. A user recognizes the exemplary dose cup 100 is not intended to be set down on the bottom wall 104. In the embodiment of FIG. 1C the vertical sidewall 102 is tapered at an angle θ to provide a tapered flange such that the opening 110 of the dose cup 100 has a diameter greater than that of a concave cavity 112. This tapered configuration facilitates the dose cup 100 being placed on a medicine bottle cap and permits the dose cup 100 to fit a variety of different sizes of medicine bottle caps. The tapered flange also influences the evacuation of the liquid medication during use. Additionally, the tapered flange also provides added structural strength to the dose cup that permits the vertical sidewall 102 to be substantially thinner than a corresponding dose cup that lacks the tapered flange. For example, in one embodiment, the vertical sidewalls and bottom wall are between 0.1 and 0.5 mm thick. This results in a significant reduction of the mass of the dose cups and a corresponding reduction in the amount of plastic that is used. The angle θ of the tapered flange may be, for example, between 5° and 20°. In another embodiment, the angle θ is between 5° and 10°.

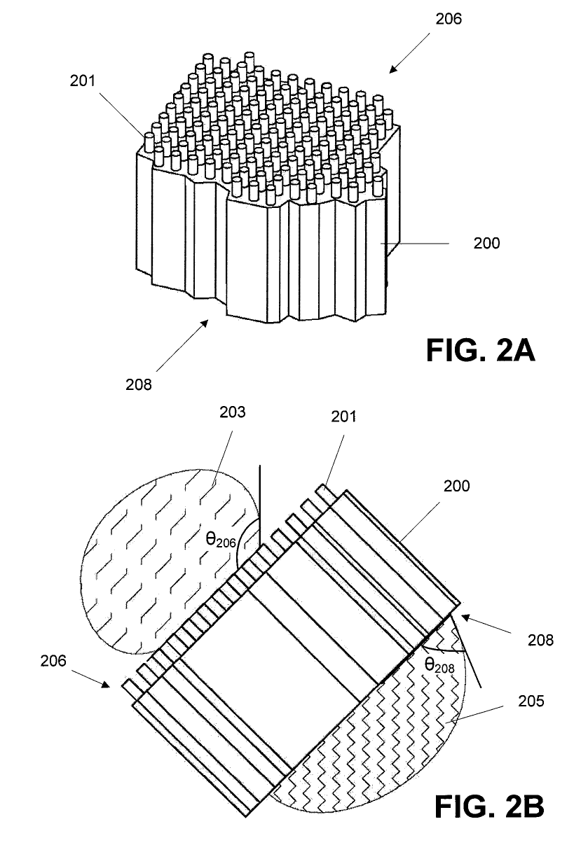

FIG. 2A and FIG. 2B are schematic depictions of surface treatments that accentuates the ability of a dose cup to dispense a controlled volume of liquid medication. The surface treatments may be applied to any of the dose cups described in this disclosure. A dose cup 200 is depicted that comprises an inner surface 206 and an outer surface 208. For example, the inner surface 206 may be on the vertical sidewall 102 and/or the bottom wall 104 of the dose cup 100. The inner surface 206 faces the concave cavity 112 such that the inner surface 206 contacts liquid medication disposed in the concave cavity 112. The inner surface 206 is surface-coated with a plurality of microstructures 201 that increase the hydrophobicity of the inner surface 206. Hydrophobicity may be measured by, for example, contact angle with water. For example, the inner surface 206 strikes a contact angle θ₂₀₆ with a drop of water 203. The contact angle θ₂₀₆ is greater than 90° when tested in accordance with ASTM D7334-08(2013) “Standard Practice for Surface Wettability of Coatings, Substrates and Pigments by Advancing Contact Angle Measurement.” In one embodiment, the contact angle θ₂₀₆ is greater than 140°. In contrast, the exemplary embodiment of FIG. 2B depicts the outer surface 208 striking a contact angle θ₂₀₈ with a drop of water 205. The contact angle θ₂₀₈ is less than 90° when tested in accordance with ASTM D7334-08(2013).

The plurality of microstructures 201 may be surface-coated by known methods. For example, the techniques disclosed in U.S. Pat. No. 8,310,760 may be used to form the plurality of microstructures 201. In one embodiment, the disclosed dose cups are manufactured by injection molding and the surface-coating is performed after the injection molding. The specified microstructures may be machined into a steel core mold with a laser. In another embodiment, the microstructures are added to the inner surface after molding has been completed. The tapered flange facilitates removal of the dose cup from a mold after injection molding. The dose cups described in this disclosure may have their gradations made in the polymeric material as grooves during the injection molding. Forming the gradations as grooves during injection molding provides significantly more accurate control over the placement of the gradations compared to printed gradations placed after the dose cup has been formed. Volume labels (e.g. “5 mL”) may be pad printed adjacent the gradations because the positioning of the labels does not impact the volume of liquid medication delivered.

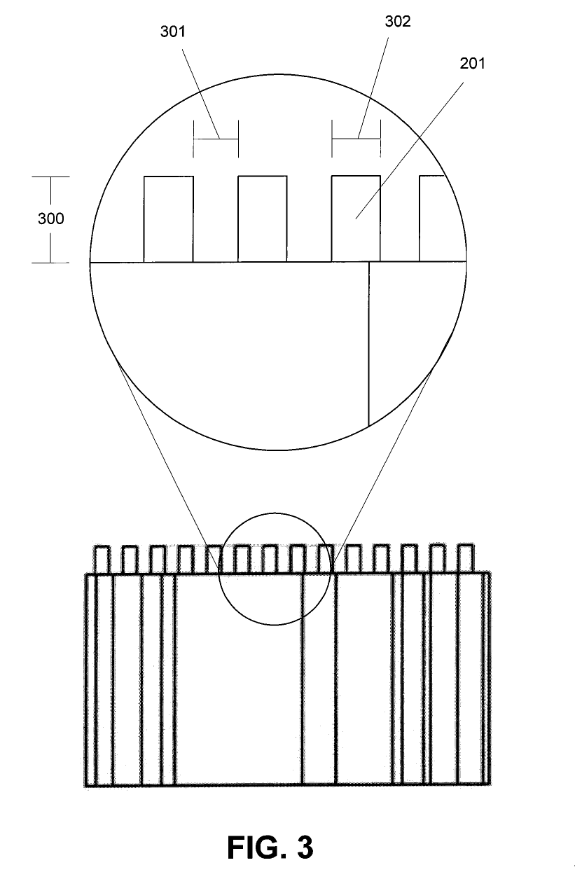

FIG. 3 depicts the plurality of microstructures 201 in further detail. In the exemplary embodiment of FIG. 3, the plurality of microstructures 201 are elongated columns with a height 300 and a width 302, wherein the height 300 is greater than the width 302. In one embodiment, the height 300 is at least twice as large as the width 302. In one embodiment, the height 300 is between twenty microns and one hundred microns and the width 302 is between ten microns and fifty microns. In another embodiment, the height 300 is between forty microns and sixty microns and the width is between twenty microns and thirty microns. In one such embodiment, the height 300 is about fifty microns and the width 302 is about twenty-five microns. Each column is spaced from neighboring columns by a gap 301. In one embodiment, the gap 301 is about the same size as the width 302. In one such embodiment, the gap 301 is about twenty-five microns. The columns may have any suitable shape. For example, the columns may be shaped as cylinders with circular lateral cross sections (see FIG. 2A) or the columns may be shaped as rectangles with square or rectangular lateral cross sections.

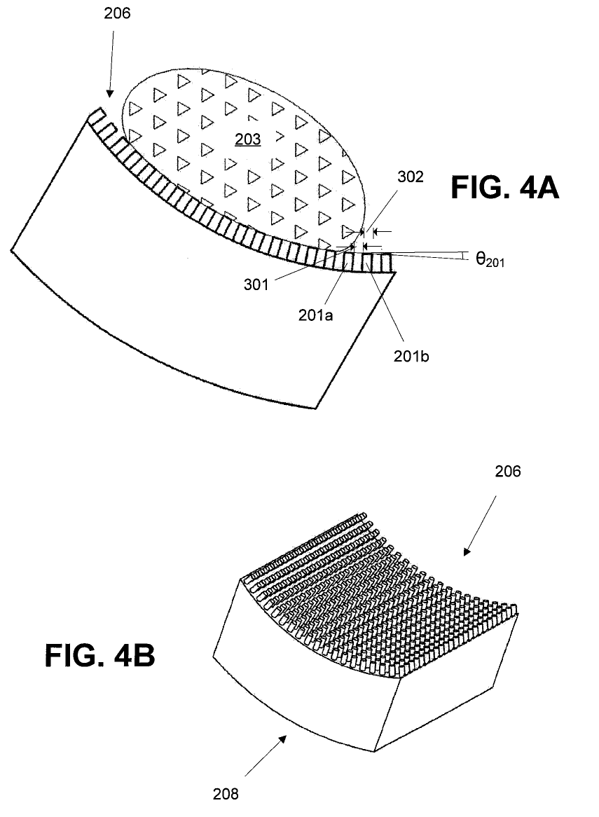

The presence of a curved inner surface, such as the curved inner surface 106 of the dose cup 100, raises special considerations. The gap 301 may be controlled to minimize disruptions in the contact angle caused by changes in the microstructures 201 as the drop of water travels over the curved inner surface. For example, and with reference to FIG. 4A, microstructures, including microstructure 201a and an adjacent microstructure 201b are disposed on a curved inner surface 206. The microstructures 201a and 201b are laterally spaced from one another along the curved inner surface 206. A top planar surface of the microstructure 201 a defines a first plane. A top planar surface of the microstructure 201b defines a second plane. Due to the curvature of the curved inner surface 206, the first plane and the second plane intersect, but are not coplanar. In one embodiment, the first plane and the second plane are offset at an angle that is greater than 0° and is less than 5°. The ratio of the gap 301 to the width 302 minimizes the angle θ₂₀₁ between the first plane and the second plane and therefore reduces the disruptions in the contact angle. In one embodiment, the ratio of the gap 301 to the width 302 is about a 1:1 ratio. In another embodiment, the ratio is less than 1:1, for example, 0.5:1. FIG. 4B is a perspective view of the microstructures shown in cross section in FIG. 4A.

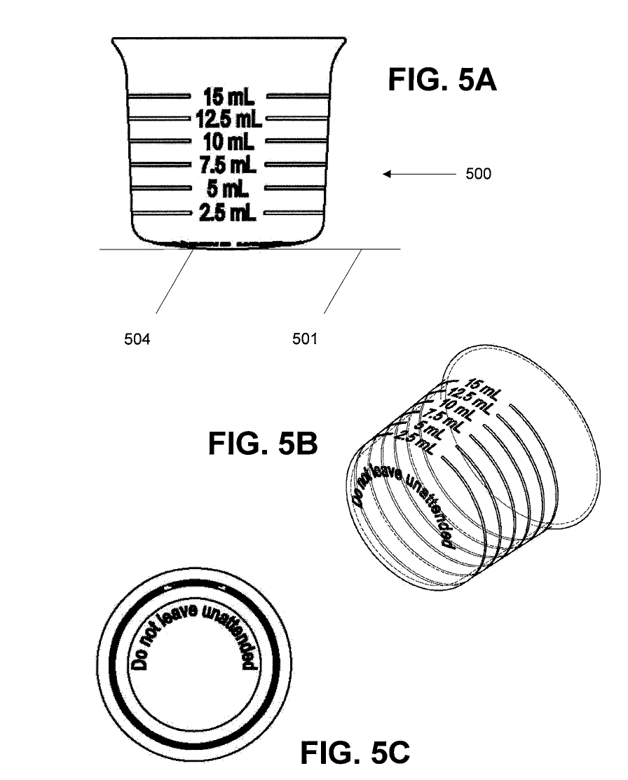

FIG. 5A is a side view of an exemplary dose cup 500. FIG. 5B is a perspective bottom view of the dose cup 500. FIG. 5C is a bottom plan view of the dose cup 500. Like dose cup 100, the dose cup 500 has a bottom wall 504 with a curved surface. Accordingly, the dose cup 500 will tip when placed on a plane 501. The user recognizes the dose cup 500 is not intended to be set down and instead grips the dose cup 500 in his or her hand. Gravity causes any liquid medication disposed within the dose cup 500 to form a level plane. The dose cup 500 includes circular gradations that extend over at least 75% of the perimeter of the dose cup 500. Because the circular gradations are present along most of the perimeter of the dose cup 500, the user can align the level plane formed by the liquid medication with the entire circular gradation to achieve more accurate dosing.

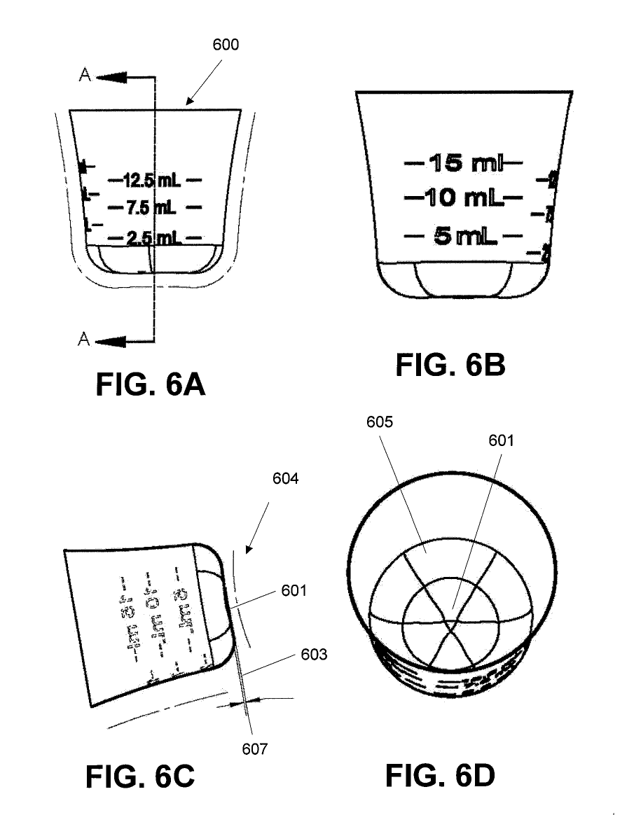

FIG. 6A, FIG. 6B, FIG. 6C and FIG. 6D depict a dose cup 600. FIG. 6A is a plan side view of the dose cup 600. FIG. 6B is a cross section view of the dose cup 600 taken along line A-A of FIG. 6A. FIG. 6C is a plane side view of the dose cup 600 in a tipped state. FIG. 6D is a top perspective view of the dose cup 600 showing its inner cavity. The dose cup 600 comprises a vertical sidewall 602 and a bottom wall 604 joined by a curved inner surface 606. The bottom wall 604 further comprises a convex bump 601 that is circumvented by a concave trough 605. The concave trough 605 contacts the curved inner surface 606. The bottom, outward side of the concave trough 605 defines a plane 603 that provides a flat surface. The convex bump 601 has a vertex that is a distance 607 above the plane 603. In one embodiment the distance 607 is about 0.3 to 0.6 mm. In another embodiment, the distance 607 is about 0.5 mm (about 0.018 inches). In use, the convex bump 601 encourages liquid to flow into the concave trough 605 and away from the center of the dose cup 600. Such a configuration promotes complete evacuation of the dose cup.

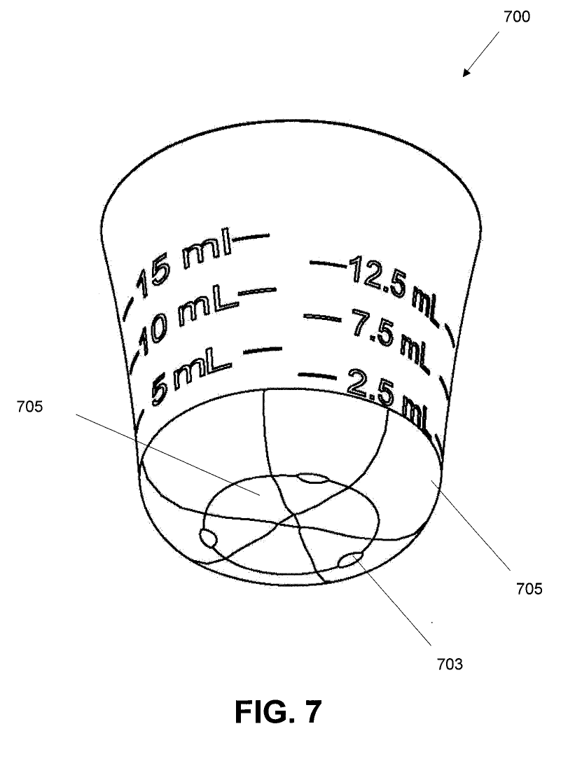

FIG. 7 is a bottom perspective view of a dose cup 700. The dose cup 700 comprises a raised foot 703 that extends from the outward side of a concave trough 705 that circumscribes a convex bump 701. In the embodiment of FIG. 7, there are three such raised feet. In other embodiments, the raised feet may have alternative configurations such as a single raised foot in the shape of, for example, a raised ring. In other embodiments, two or more raised feet are present, each in the shape of a partial circle. In yet another embodiment, three or more raised feet are present, each in the shape of a protrusion. In the embodiment of FIG. 7, three such protrusions are shown at the interface between the convex bump 701 and the concave trough 705.

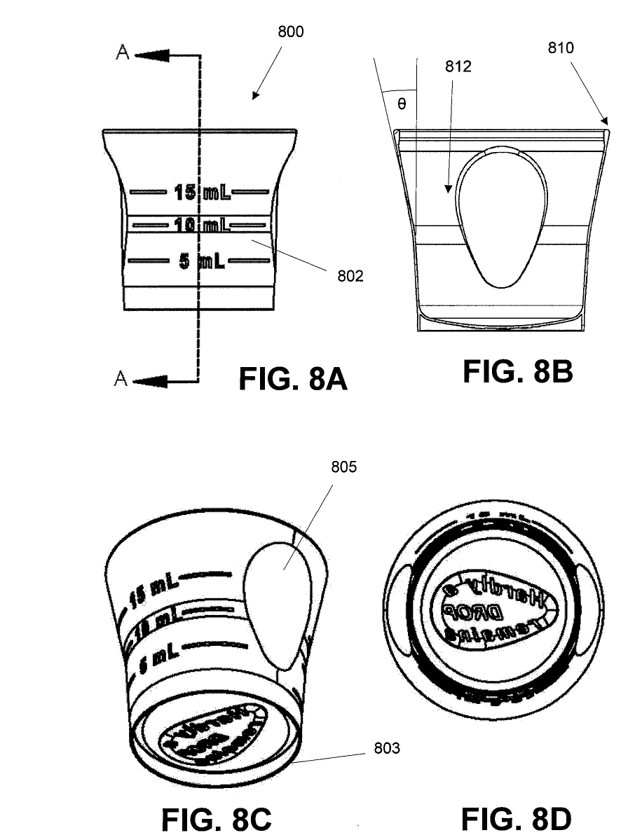

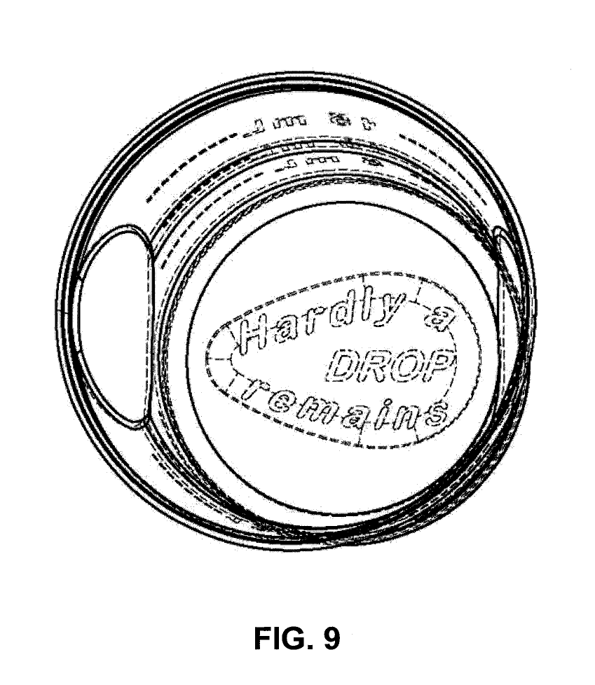

FIG. 8A, FIG. 8B, FIG. 8C and FIG. 8D depict a dose cup 800. FIG. 8A is a plan side view of the dose cup 800. FIG. 8B is a cross section view of the dose cup 800 taken along line A-A of FIG. 8A. FIG. 8C is a bottom perspective view of the dose cup 800. FIG. 8D is a bottom plan view of the dose cup 800. FIG. 9 is a top perspective view of the dose cup 800 showing its concave cavity. Dose cup 800 comprises a vertical sidewall 802 is tapered at an angle θ to provide a tapered flange such that the opening 810 of the dose cup 800 has a diameter greater than that of a concave cavity 812. Dose cup 800 further comprises a raised foot 803 that, in the embodiment of FIG. 8C, is in the shape of a raised ring. The dose cup 800 further comprises a gripping feature 805 in the vertical sidewall 802. In dose cup 800, the gripping feature 805 is a surface with a curvature that is different than the curvature of the portion of the 802 that circumscribes the gripping feature 805.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A dose cup for dispensing liquid medication, the dose cup comprising a vertical sidewall and a bottom wall joined together by a curved inner surface to define an inner cavity, where the inner cavity is surface-coated with a plurality of microstructures that provides a hydrophobic surface to produce a contact angle greater than 90° when tested in accordance with ASTM D7334-08(2013), the dose cup comprising a polymeric material.

2. The dose cup as recited in claim 1, wherein the inner cavity is a concave cavity.

3. The dose cup as recited in claim 1, wherein the inner cavity comprises a concave trench that circumscribes a convex bump, the concave trench and the convex bump being disposed on the bottom wall.

4. The dose cup as recited in claim 1, wherein the dose cup has an opening defined by a tapered flange such that a diameter of the opening of the dose cup is greater than a diameter of the inner cavity.

5. The dose cup as recited in claim 1, wherein the dose cup has an opening defined by a tapered flange such that a diameter of the opening of the dose cup is greater than a diameter of the inner cavity and wherein the vertical sidewall is between 0.1 mm and 0.5 mm thick.

6. The dose cup as recited in claim 1, wherein the inner cavity has been surface treated to produce the contact angle greater than 90° and an outer surface of the dose cup has not been surface treated such the outer surface has second contact angle less than 90° when tested in accordance with ASTM D7334-08(2013).

7. The dose cup as recited in claim 1, wherein at least one raised foot extends from an outward side of the bottom wall to define a lower plane for holding the dose cup upright.

8. The dose cup as recited in claim 1, wherein at least three raised feet extend from an outward side of the bottom wall to define a lower plane for holding the dose cup upright.

9. The dose cup as recited in claim 1, wherein a raised foot extends from an outward side of the bottom wall to define a lower plane for holding the dose cup upright, the raised foot having a shape of a raised ring.

10. A dose cup for dispensing liquid medication, the dose cup comprising a vertical sidewall and a bottom wall joined together by a curved inner surface to define an inner cavity, where the inner cavity is surface-coated with a plurality of microstructures that provides a hydrophobic surface to produce a contact angle greater than 90° when tested in accordance with ASTM D7334-08(2013), the dose cup comprising a polymeric material, the plurality of microstructures comprising columns, each with a height, a width and a top planar surface, the height being at least twice the width, the columns being spaced apart by a gap that is equal to or less than the width.

11. The dose cup as recited in claim 10, where the plurality of microstructures comprises a first column with a first top planar surface that defines a first plane and a second columns with a second top planar surface that defines a second plane, the first column and the second column being adjacent and disposed on the curved inner surface, wherein the first plane and the second plane are offset at an angle that is greater than 0° and less than 5°.

12. The dose cup as recited in claim 10, wherein the width is about twenty five microns, the gap is equal to or less than twenty five microns and the height is at least fifty microns.

13. The dose cup as recited in claim 10, wherein the dose cup has an opening defined by a tapered flange such that a diameter of the opening of the dose cup is greater than a diameter of the inner cavity and wherein the vertical sidewall is between 0.1 mm and 0.5 mm thick.

14. The dose cup as recited in claim 10, wherein the inner cavity comprises a concave trench that circumscribes a convex bump, the concave trench and the convex bump being disposed on the bottom wall.

15. The dose cup as recited in claim 10, wherein at least one raised foot extends from an outward side of the bottom wall to define a lower plane for holding the dose cup upright.

16. The dose cup as recited in claim 10, wherein at least three raised feet extend from an outward side of the bottom wall to define a lower plane for holding the dose cup upright.

17. The dose cup as recited in claim 10, wherein a raised foot extends from an outward side of the bottom wall to define a lower plane for holding the dose cup upright, the raised foot having a shape of a raised ring.

18. The dose cup as recited in claim 10, wherein the dose cup comprises gradations on the vertical sidewall that are grooves.

19. The dose cup as recited in claim 18, wherein the gradations are circular gradations that extend over at least 75% of a perimeter of the inner cavity.
